(19) United States
(12) Patent Application Publication
(10) Pub. No.: US 2010/0227175 A1
(43) Pub. Date: Sep. 9, 2010

(54) METHOD FOR FUSION BONDING MOLDED ARTICLE OF LIQUID CRYSTALLINE POLYMER AND GLASS SUBSTRATE TO EACH OTHER AND COMPOSITE ARTICLE OBTAINED BY THE METHOD

(75) Inventors: Yuichi SAKA, Tsukuba-shi (JP); Mitsuo MAEDA, Tsukuba-shi (JP); Yasuo MATSUMI, Tsukuba-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Tokyo (JP)

(21) Appl. No.: 12/717,690

(22) Filed: Mar. 4, 2010

(30) Foreign Application Priority Data
Mar. 6, 2009 (JP) 2009-053935

(51) Int. Cl. B32B 17/10; B29C 65/02

(52) U.S. Cl. 428/426; 156/60

(57) ABSTRACT

A method for fusion bonding a molded article of a liquid crystalline polymer and a glass substrate to each other, comprising bringing the molded article into contact with the glass substrate; and setting the temperature of a contact portion of the molded article in contact with the glass substrate, at a predetermined temperature, wherein when the predetermined temperature of the contact portion is represented by T₁(° C.), a flow initiation temperature of the liquid crystalline polymer is represented by T₂(° C.) and a decomposition initiation temperature of the liquid crystalline polymer is represented by T₃(° C.), the following relation is satisfied:

T₃(° C.)>T₁(° C.)≧T₂(° C.)+80° C.

### BACKGROUND OF THE INVENTION

1. Field of the Invention

The present invention relates to a method for fusion bonding a molded article of a liquid crystalline polymer and a glass substrate to each other and a composite article obtained by the method.

2. Related Background Art

As a lid for a case for housing a semiconductor element, there has hitherto been known a lid in which a glass substrate as a window is fit in a frame-shaped lid frame. Usually, the lid frame of the case for housing a semiconductor is a resin molded article, and a method using an adhesive is known as a method for adhering a resin molded article and a glass substrate to each other.

Additionally, U.S. Pat. No. 7,135,768 describes a method for adhering a glass substrate and a lid frame, which is a resin molded article, to each other by insert molding.

However, such methods that use adhesives involve complicated control of the steps such as the step of applying an adhesive and hence the steps thereof tend to be cumbersome. Additionally, when an adhesive is used, because of the reasons including the possibilities that the low boiling point components contained in the adhesive may partially vaporize and the adhesion portion formed with the adhesive may have hygroscopicity, it is difficult to sufficiently enhance the sealing property (air-tightness) of the adhesive. Further, because a glass substrate is fragile, the handling including the positioning of the glass substrate is difficult in a method adopting the insert molding, and hence the steps in the method adopting the insert molding tend to be cumbersome in a manner similar to the case where adhesives are used; however, U.S. Pat. No. 7,135,768 describes no details of the conditions related to the insert molding.

### SUMMARY OF THE INVENTION

In view of the above-described circumstances, an object of the present invention is to provide a method for fusion bonding a molded article of a liquid crystalline polymer and a glass substrate to each other, capable of fusion bonding the molded article of a liquid crystalline polymer and the glass substrate to each other without using any adhesive with a simple step, and capable of imparting a sufficient air-tightness to the fusion bonded portion, and a composite article produced by the method.

The method according to the present invention is a method for fusion bonding a molded article of a liquid crystalline polymer and a glass substrate to each other, by bringing the molded article of a liquid crystalline polymer (hereinafter, referred to as a liquid crystalline polymer molded article, as the case may be) into contact with the glass substrate and by setting at a predetermined temperature the temperature of the contact portion of the liquid crystalline polymer molded article, in contact with the glass substrate. And, when the predetermined temperature of the contact portion is represented by T₁(° C.), a flow initiation temperature of the liquid crystalline polymer is represented by T₂(° C.) and a decomposition initiation temperature of the liquid crystalline polymer is represented by T₃(° C.), the following relation is satisfied:

T₃(° C.)>T₁(° C.)T₂(° C.)+80° C.

According to the method of the present invention, by satisfying the above-described relation, the contact portion of the liquid crystalline polymer molded article, in contact with the glass substrate is made to sufficiently flow, and hence the molded article and the glass substrate can be strongly fusion bonded to each other, and the decomposition of the liquid crystalline polymer and the deformation of the liquid crystalline polymer molded article can also be suppressed. Moreover, the method of the present invention is a method which neither uses any adhesive nor performs insert molding, and hence the steps involved are made simpler. Additionally, the method of the present invention does not use any adhesive and directly fusion bonds the molded article to the glass substrate, and hence can realize a sufficient air-tightness in the fusion bonded portion.

Here, under the condition that the temperature of the contact portion is set at T₁, it is preferable to press the glass substrate against the contact portion of the liquid crystalline polymer molded article. By this pressing, the fusion bonding strength of the composite article composed of the liquid crystalline polymer molded article and the glass substrate can be enhanced and the air-tightness of the composite article can be more enhanced.

Additionally, the pressure at the time of performing the pressing is preferably 10 MPa or less. When the pressure is 10 MPa or less, the shape of the molded article and the shape of the glass substrate are hardly damaged and the production of the composite article is facilitated.

Additionally, the time period of the pressing is preferably 10 seconds or less. When the time period of the pressing is 10 seconds or less, the decomposition of the liquid crystalline polymer and the deformation of the liquid crystalline polymer molded article are particularly easily suppressed.

Additionally, the surface of the glass substrate brought into contact with the liquid crystalline polymer molded article is preferably being surface treated with at least one selected from the group consisting of magnesium fluoride, zirconia and aluminum oxide.

Additionally, the surface of the glass substrate brought into contact with the liquid crystalline polymer molded article is preferably being surface roughened.

The surface treatment of the glass substrate more improves the affinity of the liquid crystalline polymer itself to the glass substrate. Additionally, the surface roughening treatment of the glass substrate surface can increase the contact area of the glass substrate to the fusion bonded portion of the liquid crystalline polymer molded article after the fusion bonding. The application of these treatments can more enhance the air-tightness of the composite article composed of the liquid crystalline polymer molded article and the glass substrate.

Additionally, the contact portion of the liquid crystalline polymer molded article preferably has one or more protrusions. The one or more protrusions possessed by the contact portion in contact with the glass substrate facilitate uniform adhesion of the liquid crystalline polymer of the liquid crystalline polymer molded article to the glass substrate.

The composite article according to the present invention is a composite article including the liquid crystalline polymer molded article and the glass substrate, fusion bonded to each other by the above-described fusion bonding method. The composite article is obtained by using the above-described fusion bonding method, and hence the produced composite article is low in cost and the air-tightness of the composite article can be enhanced.

According to the present invention, the molded article of a liquid crystalline polymer and the glass substrate can be fusion bonded to each other without using any adhesive with a simple step, and a sufficient air-tightness can be imparted to the fusion bonded portion.

### BRIEF DESCRIPTION OF THE DRAWINGS

FIG. 1(a) is a perspective view illustrating a lid frame constituting a lid member according to an embodiment of the present invention, and FIG. 1(b) is a sectional view along the line I-I of the lid frame of FIG. 1(a);

FIGS. 2(a) to 2(d) are a process drawing schematically illustrating a method for fusion bonding the lid frame and a glass substrate to each other; and

FIG. 3 is a sectional view illustrating an embodiment of a thermal fusion bonding apparatus of the present invention.

### DESCRIPTION OF THE PREFERRED EMBODIMENT

Hereinafter, the preferred embodiment of the present invention is described in detail with reference to the accompanying drawings. It is to be noted that in the description of the drawings, the same or the corresponding elements are denoted by the same symbols and redundant descriptions are omitted, and the dimensional proportions of the individual drawings are not necessarily in agreement with the actual dimensional proportions.

(Fusion Bonding Method)

Here, by taking as an example the production of a lid for a case for housing a semiconductor element, description is made on a method for fusion bonding a molded article of a liquid crystalline polymer and a glass substrate to each other.

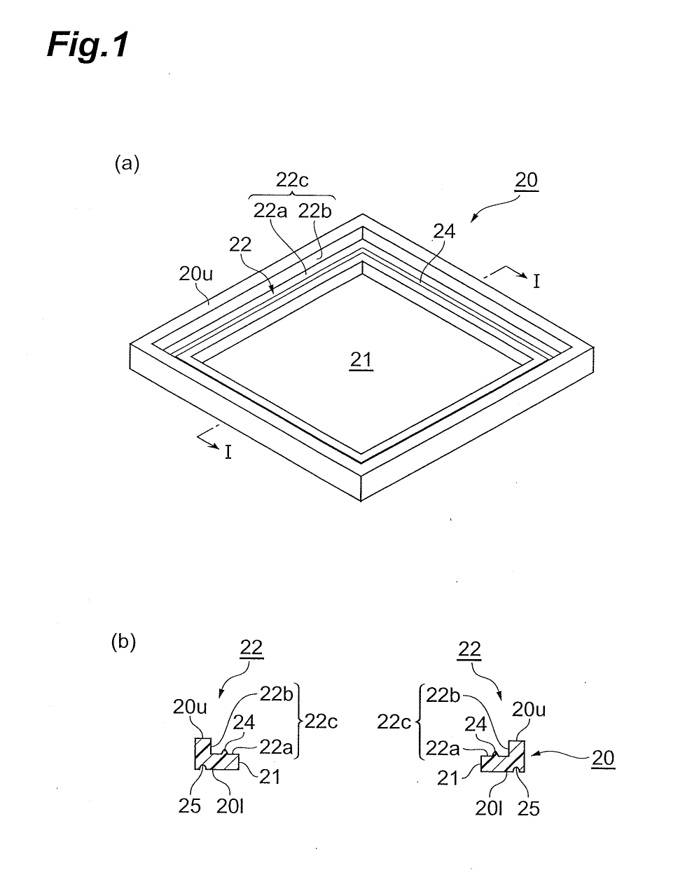

First, as the molded article of a liquid crystalline polymer, a lid frame 20 which is a part of the constituent members of a lid is prepared, as shown in FIG. 1(a).

The lid frame 20 as a molded article of a liquid crystalline polymer is a frame-shaped member which has a rectangular through-hole 21 and a rectangular external form. A step portion 22 forming a level difference in relation to one of the main surfaces (upper surface 20u) of the lid frame 20 is formed along the outer perimeter of the through-hole 21 around the through-hole 21 in the upper surface 20u. Therefore, as shown in FIG. 1(b), the cross-sectional shape of the lid frame 20 is approximately of an L-shape. The bottom surface 22a and the inner wall 22b of the step portion 22 serve as a contact portion 22c brought into contact with a glass substrate (to be described below). The bottom surface 22a has a raised line (protrusion) 24 formed along the brim of the through-hole 21 so as to surround the through-hole 21. It is to be noted that the raised line 24 possessed by the bottom surface 22a facilitates the uniform contact of the liquid crystalline polymer in the contact portion 22c with the glass substrate in the below-described fusion bonding step, and hence the air-tightness is more improved. The cross sectional shape of the raised line 24 is not particularly limited, and may be, for example, a ridge-like cross-sectional shape.

A frame-shaped groove or a frame-shaped protrusion is formed on the lower surface 201 of the lid frame 20 so as to surround the through-hole 21. FIG. 1(b) shows a case where a frame-shaped groove 25 is formed.

Next, description is made on the liquid crystalline polymer which is the material for the lid frame 20.

A liquid crystalline polymer is a polymer referred to as a thermotropic liquid crystalline polymer, and is preferably a liquid crystalline polyester in the present invention. The liquid crystalline polymer forms a melt exhibiting an optical anisotropy at 450° C. or lower, and specific examples of the liquid crystalline polymer include the following:

(1) A polymer obtained by polymerizing a combination of an aromatic hydroxycarboxylic acid, an aromatic dicarboxylic acid and an aromatic diol

(2) A polymer obtained by polymerizing a plurality of types of aromatic hydroxycarboxylic acids

(3) A polymer obtained by polymerizing a combination of an aromatic dicarboxylic acid and an aromatic diol

(4) A polymer obtained by reacting an aromatic hydroxycarboxylic acid with a crystalline polyester such as polyethylene terephthalate

It is to be noted that with respect to the production of the liquid crystalline polymer, in place of the above-described aromatic hydroxycarboxylic acid, aromatic dicarboxylic acid or aromatic diol, the ester-forming derivatives of these may also be used, and to the production of the liquid crystalline polymer by using the ester forming derivatives, heretofore known techniques are applied, and such techniques are described below.

Hereinafter, detailed description is made on the above-described liquid crystalline polymer (1) (liquid crystalline polyester) which is a preferable liquid crystalline polyester. The liquid crystalline polyester is a polymer including a structural unit derived from an aromatic hydroxycarboxylic acid, an aromatic dicarboxylic acid and an aromatic diol, and the specific examples of such a structural unit include the following structural units.

The structural units derived from aromatic hydroxycarboxylic acids:

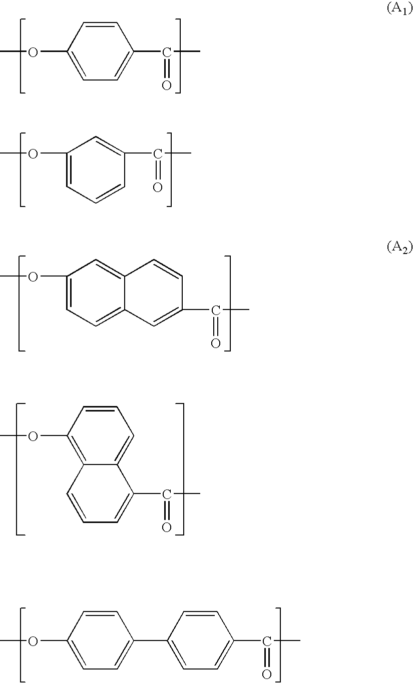

The above-described structural units may each have a halogen atom, an alkyl group or an aryl group as a substituent group.

Structural units derived from aromatic dicarboxylic acids:

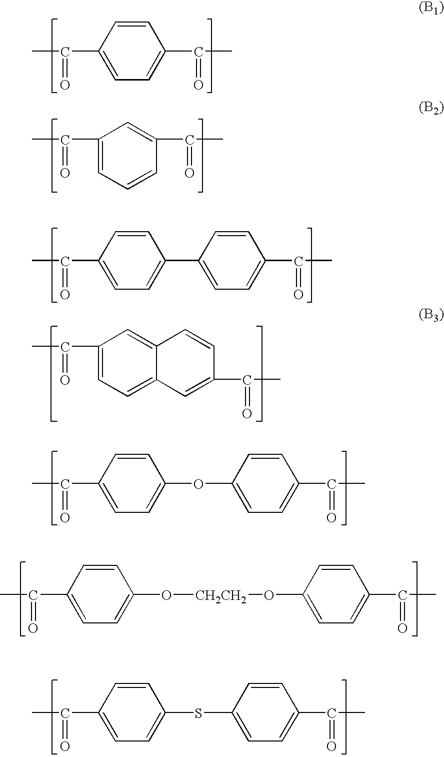

The above-described structural units may each have a halogen atom, an alkyl group or an aryl group as a substituent group.

Structural units derived from aromatic diols:

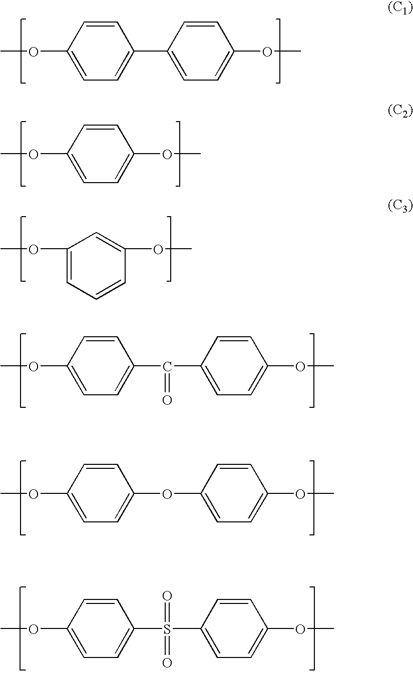

The above-described structural units may each have a halogen atom, an alkyl group or an aryl group as a substituent group.

Examples of the combinations of the structural units of the preferable liquid crystalline polymers (liquid crystalline polyesters) may include the following (a) to (h).

(a): A combination composed of (A₁), (B₁) and (C₁) or a combination composed of (A₁), (B₁), (B₂) and (C₁)

(b): A combination composed of (A₂), (B₃) and (C₂) or a combination composed of (A₂), (B₁), (B₃) and (C₂)

(c): A combination composed of (A₁) and (A₂)

(d): A combination in which in each of the structural unit combinations of (a), part or the whole of (A₁) is replaced with (A₂)

(e): A combination in which in each of the structural unit combinations of (a), part or the whole of (BO is replaced with (B₃)

(f): A combination in which in each of the structural unit combinations of (a), part or the whole of (CO is replaced with (C₃)

(g): A combination in which in each of the structural unit combinations of (b), part or the whole of (A₂) is replaced with (A₁)

(h): A combination in which to the structural unit combination (c), (B₁) and (C₂) are added

As the above-described (a) to (h), the liquid crystalline polymer (liquid crystalline polyester) used in the present invention preferably includes (A₁) and/or (A₂) as the structural unit derived from an aromatic hydroxycarboxylic acid, one or more selected from the group consisting of (B₁), (B₂) and (B₃) as the structural units derived from aromatic dicarboxylic acids, and one or more selected from the group consisting of (C₁), (C₂) and (C₃) as the structural units derived from aromatic diols. It is to be noted that these structural units may have substituent groups in the aromatic rings thereof as described above, but these structural units preferably do not have such substituent groups when the liquid crystalline polymer molded article is required to have a higher level of heat resistance.

As the method for producing the liquid crystalline polymer, various heretofore known methods can be adopted, but preferable is such a method for producing a liquid crystalline polymer that has been proposed by the present applicant in Japanese Patent Laid-Open No. 2004-256673.

The liquid crystalline polymer preferable for use in the present invention has been described as presented above. However, for the purpose of producing the liquid crystalline polymer molded article (lid frame 20), the liquid crystalline polymer may include, in addition to the liquid crystalline polymer, various additives such as an inorganic filler where necessary, according to the demanded properties of the liquid crystalline polymer molded article.

Such a lid frame 20 can be produced by a heretofore known method such as an injection molding method.

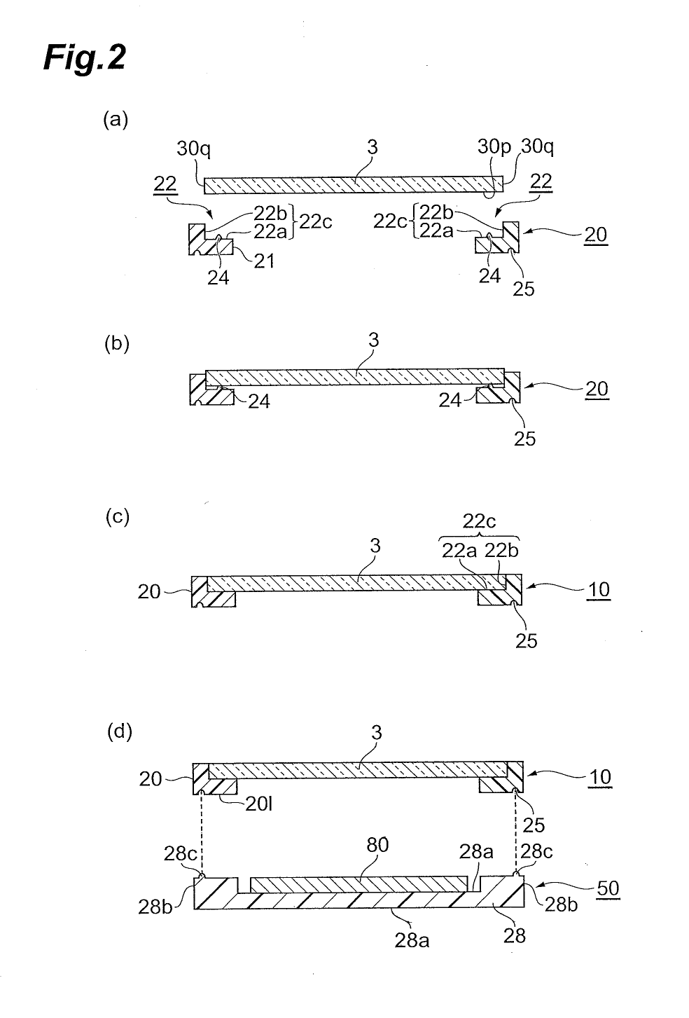

Next, a glass substrate 3 as shown in FIG. 2 is prepared. In present Embodiment, the glass substrate 3 is a rectangular plate. The size of the glass substrate 3 is such that the peripheral portion 30p of the glass substrate 3 is over the full perimeter in contact with the bottom surface 22a of the contact portion 22c of the lid frame 20, the peripheral side portion 30q of the glass substrate 3 is over the full perimeter in contact with the inner wall 22b, and the glass substrate 3 is capable of covering the through-hole 21. The thickness of the glass substrate 3 is not particularly limited.

Examples of the material for the glass substrate 3 include soda-lime glass, quartz glass, phosphosilicate glass, fluoride glass, lead glass, lanthanum glass, barium glass, borosilicate glass and aluminosilicate glass.

Here, the peripheral portion 30p, which is a portion of the glass substrate 3, in contact with the bottom surface 22a of the contact portion 22c of the lid frame 20, and the peripheral side portion 30q, which is a portion of the glass substrate 3, in contact with the inner wall 22b of the contact portion 22c of the lid frame 20, are preferably being surface treated with at least one surface treatment material selected from the group consisting of magnesium fluoride, zirconia and aluminum oxide. The peripheral portion 30p and the peripheral side portion 30q of the glass substrate 3 are preferably being surface roughened. By subjecting the surfaces of the glass substrate 3, in contact with the lid frame 20, to the surface treatment or the surface roughening treatment, the air-tightness of the composite article composed of the lid frame 20 and the glass substrate 3 can be enhanced.

The surface treatment may be performed, for example, as follows: the solutions or the dispersions are prepared by using the above-described surface treatment materials and appropriate solvents, and the resulting solutions or dispersions are applied by spin coating or the like; and targets made of the above-described surface treatment materials are prepared, and sputtering treatment or vapor deposition treatment is performed by using the targets.

More detailed examples of the surface treatment with the above-described preferable surface treatment materials may include the following methods: as a surface treatment of the glass substrate with magnesium fluoride, a method in which, for example, Ar (argon) gas is used as a sputtering gas and fluorine (F₂) gas diluted with Ar gas is used as a reaction gas, a magnesium target is sputtered, and the gas generated by the sputtering is deposited on the surface of the glass substrate; a method in which magnesium fluoride is used as a vapor deposition material, the magnesium fluoride is heated to be vaporized with irradiation of an electron beam, and the vaporized gas is deposited on the surface of the glass substrate; and a method in which a sol solution prepared with hydrofluoric acid and magnesium acetate is applied onto the surface of the glass substrate by spin coating or the like.

Examples of the surface treatment with zirconia may include: a method in which zirconia (ZrO₂) is used as a vapor deposition material, the zirconia is heated to be vaporized with irradiation of an electron beam, and the vaporized gas is deposited on the surface of the glass substrate; and a method in which a zirconium oxide sol is applied onto the surface of the glass substrate by spin coating or the like.

Examples of the surface treatment with aluminum oxide may include: a method in which Ar gas is used as a sputtering gas and oxygen gas is used as a reaction gas, an aluminum target is sputtered, and the gas generated by the sputtering is deposited on the surface of the glass substrate; a method in which metal aluminum is used as a vapor deposition material, the metal aluminum is heated to be vaporized with irradiation of an electron beam, and the generated gas is deposited together with oxygen gas on the surface of the glass substrate; and a method in which an aluminum oxide sol is used and applied onto the surface of the glass substrate by spin coating or the like.

Additionally, the surface roughening treatment can be performed by a method in which an etching treatment is performed with an etching solution such as a mixed aqueous solution of chromic acid and dilute sulfuric acid, and dilute hydrofluoric acid, or by a sand-blasting method.

Successively, as shown in FIGS. 2(b) and 2(c), the peripheral portion 30p and the peripheral side portion 30q of the glass substrate 3 are brought into contact with the contact portion 22c of the lid frame 20, and the temperature of the contact portion 22c, in contact with the glass substrate 3, of the lid frame 20 is set at a predetermined high temperature. Here, when a flow initiation temperature of the liquid crystalline polymer constituting the interior of the lid frame 20 is represented by T₂(° C.) and a decomposition initiation temperature of the liquid crystalline polymer is represented by T₃(° C.), the predetermined temperature T₁(° C.) satisfies the following relation:

T₃(° C.)>T₁(° C.)≧T₂(° C.)+80° C.

Here, the flow initiation temperature T₂ of the liquid crystalline polymer and the decomposition initiation temperature T₃ of the liquid crystalline polymer can be measured by the following methods, respectively.

(Method for Measuring the Flow Initiation Temperature)

A flow tester CFT-500 manufactured by Shimadzu Corp. is used and an analyte sample (a liquid crystalline polymer) is heated at a temperature increase rate of 4° C./min When the liquid crystalline polymer forming a melt by heating is extruded from a nozzle having an inner diameter of 1 mm and a length of 10 mm under a load of 100 kgf/cm², the temperature at which the melt exhibits a melt viscosity of 48,000 poise is measured and this temperature is defined as the flow initiation temperature.

(Method for Measuring the Decomposition Initiation Temperature)

A thermogravimetric analyzer TGA-50 manufactured by Shimadzu Corp. is used, the analyte sample is heated at a temperature increase rate of 10° C./min in a nitrogen atmosphere, and the temperature at which the weight of the analyte is reduced by 1% is measured and this temperature is defined as the decomposition initiation temperature.

For the purpose of bringing the glass substrate 3 into contact with the lid frame 20 and setting at the predetermined temperature T₁(° C.) the temperature of the contact portion 22c of the lid frame 20, in contact with the glass substrate 3, first, the temperature of the glass substrate 3 is increased to the temperature of T₁(° C.), then the glass substrate 3 heated to T₁(° C.) is brought into contact with the contact portion 22c of the lid frame 20, and thus, the contact portion 22c, of the lid frame 20, in contact with the glass substrate 3 is heated up to a temperature T₁ approximately the same as the temperature T₁(° C.) of the glass substrate 3.

Here, it is preferable to press the glass substrate 3 against the bottom surface 22a of the lid frame 20 under the condition that the temperature of the contact portion 22c is set at T₁(° C.). By this pressing, the adhesiveness between the bottom surface 22a of the lid frame 20 and the glass substrate 3 is improved, and thus the air-tightness of the composite article is further enhanced. The pressure exerted to the bottom surface 22a at the time of the pressing is preferably 10 MPa or less. When this pressure is 10 MPa or less, the shapes of the lid frame 20 and the glass substrate 3 are hardly impaired. Additionally, the time period of the pressing is preferably 10 seconds or less. When the time period of the pressing is 10 seconds or less, the decomposition of the liquid crystalline polymer constituting the lid frame 20 and the deformation of the liquid crystalline polymer molded article can be sufficiently suppressed. As shown in FIG. 2(c), a sufficient pressing causes a sufficient collapse of the raised line 24 on the bottom surface 22a to result in a wide area contact.

Subsequently, by cooling the contact portion 22c down to a temperature lower than T₂, the lid frame 20 and the glass substrate 3 are strongly fusion bonded at the contact portion 22c. Herewith, the fusion bonding step is completed, and as shown in FIG. 2(c), a lid 10 as a composite article composed of the lid frame (the molded article of the liquid crystalline polymer) 20 and the glass substrate 3 is completed.

According to the fusion bonding method as described above, by making the temperature of the contact portion 22c at the time of the contact of the lid frame 20 with the glass substrate 3 satisfy the above-described relation, the contact portion 22c is made to sufficiently flow, and hence the lid frame 20 can be strongly fusion bonded to the glass substrate 3, and the decomposition of the liquid crystalline polymer and the deformation of the liquid crystalline polymer molded article can also be suppressed. Moreover, the above-described fusion bonding method is a method which neither uses any adhesive nor performs insert molding, and hence the steps involved are made simpler. Additionally, the fusion bonding method does not use any adhesive and directly fusion bonds the lid frame 20 to the glass substrate 3, and hence can easily produce the lid 10 having a sufficiently high air-tightness in the fusion bonded portion.

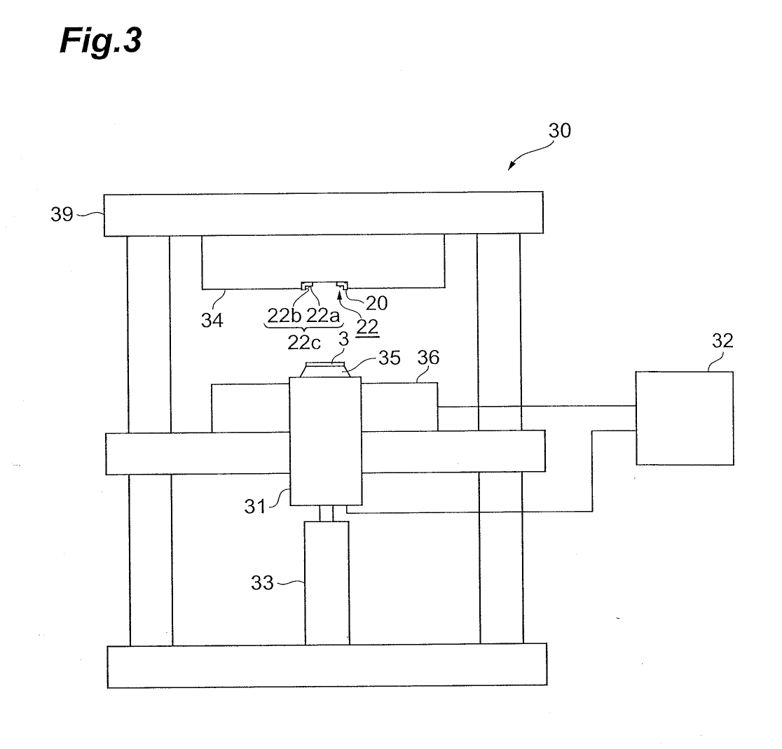

It is to be noted that in the above-described fusion bonding method, for example, a thermal fusion bonding apparatus as shown in FIG. 3 can be used. The thermal fusion bonding apparatus 30 of FIG. 3 is provided with a rack 39, a molded article holder 34 which is fixed to the rack 39 and holds the above-described lid frame 20 in such a way that the contact portion 22c faces downwardly, a glass substrate holder 35 which holds the glass substrate 3 at a position facing the lid frame 20 held by the molded article holder 34, a heater block 31 for heating the glass substrate 3 held by the glass substrate holder 35, a heater supporting block 36 supporting in a vertically movable manner the glass substrate holder 35 and the heater block 31, a temperature controller 32 for controlling the temperature of heating the glass substrate 3, and a pressing air cylinder 33 for pressing the glass substrate 3 to the lid frame 20 by moving the glass substrate holder 35 and the heater block 31.

Then, the lid frame 20 is set at the molded article holder 34 of the thermal fusion bonding apparatus 30 and the glass substrate 3 is set at the glass substrate holder 35 of the thermal fusion bonding apparatus 30, and the glass substrate 3 is heated up to T₁(° C.) with the heater block 31. Examples of the heater for heating the block in the heating block 31 include a surface heater and a rod heater, and a rod heater is particularly preferable. The temperature of the heater supporting block 36 is controlled by a temperature controller 32 in such a way that the temperature of the heater supporting block 36 is varied according to the thermal expansion of the heater block 31 at the time of heating, and the glass substrate holder 35 and the heater block 31 can be moved vertically in a smooth manner by the pressing air cylinder 33 irrespective of the temperature of the glass substrate 3.

Then, under the condition that the glass substrate 3 is heated up to T₁(° C.), the air cylinder 33 is driven, the heated glass substrate 3 is thereby brought into contact with the contact portion 22c of the lid frame 20, and is pressed to the contact portion 22c for a predetermined time under predetermined pressure. In this way, the temperature of the contact portion 22c of the lid frame 20 is easily made to be T₁(° C.), and can be brought into contact with the glass substrate 3.

The lid 10, which is a composite article composed of the lid frame 20 and the glass substrate 3 fusion bonded to each other by the above-described fusion bonding method, can be used, for example, as a lid for a case for housing a semiconductor element.

For example, as shown in FIG. 2(d), a case 50 for housing a semiconductor element in which a semiconductor device 80 such as a CCD is mounted is prepared. The case 50 for housing a semiconductor element has a lower vessel 28, which is a molded article, and the semiconductor device 80. The lower vessel 28 is preferably formed of a liquid crystalline polymer. The lower vessel 28 mainly has a rectangular bottom surface portion 28a for placing thereon the semiconductor device 80, a frame-shaped portion 28b upwardly protruding from the peripheral portion of the bottom surface portion 28a and a raised line 28c formed on the top of the frame-shaped portion 28b.

On the bottom surface portion 28a, the semiconductor device 80 is placed and fixed. In the case 50 for housing a semiconductor element, a predetermined conductive part for electrically connecting the semiconductor device 80 to the external circuits and the like is formed in such a way that the part penetrates through a side wall portion or a bottom portion of the case 50, although such an part is not shown in the figure. The terminals of the semiconductor device 80 and the predetermined conductive part are electrically connected to each other, for example, by bonding. Although also not shown, a die pad or the like may be provided on the part of the bottom surface portion 28a on which the semiconductor device 80 is placed.

The frame-shaped portion 28b has a frame-shaped form that corresponds to the lower surface 201 of the lid frame 20 of the lid 10, and on the top of the frame-shaped portion 28b, the raised line 28c that can fit into a groove 25 formed on the lower surface 201 of the lid frame 20 is formed. Alternatively, conversely, a structure may also be adopted in which a raised line is formed on the lower surface 201 of the lid frame 20, and a groove that can fit to the raised line is formed on the frame-shaped portion 28b. Here, description is made on the case where the groove 25 is formed on the lower surface 201 of the lid frame 20 and the raised line 28c is formed on the frame-shaped portion 28b.

The groove 25 on the lower surface 201 of the lid frame 20 and the raised line 28c on the frame-shaped portion 28b of the lower vessel 28 of the case 50 for housing a semiconductor element are made to fit to each other for positioning, and for example, the lower surface 201 of the lid frame 20 and the frame-shaped portion 28b of the lower vessel 28 are fusion bonded to each other by using ultrasonic welding method; in this way, a semiconductor package having a high air-tightness can be obtained at a low cost.

It is to be noted that the present invention is not limited to the above-described embodiment, but various modified embodiments are possible.

For example, in the above-described embodiment, when the molded article (lid frame 20) and the glass substrate 3 are fusion bonded to each other, the peripheral portion 30p and the peripheral side portion 30q of the glass substrate 3 are both brought into contact with the contact portion 22c of the lid frame 20; however, the present invention can be embodied even if the peripheral side portion 30q of the glass substrate 3 is not necessarily brought into contact with the lid frame 20.

Additionally, in the above-described embodiment, the surface of the step portion 22 of the molded article (lid frame 20) is adopted as the contact portion 22c in contact with the glass substrate 3, but a place other than the step portion 22 may be adopted as the contact portion in contact with the glass substrate 3, for example, in such a way that the upper surface 20u of the lid frame 20 may be adopted as the contact portion.

Additionally, in the above-described embodiment, the glass substrate 3 is beforehand heated, and then brought into contact with the molded article (lid frame 20). However, the contact portion of the molded article is beforehand heated and then the contact portion may be brought into contact with the glass substrate; alternatively both of the glass substrate and the contact portion of the molded article are beforehand heated, and then may be brought into contact with each other; or further alternatively, any one of the glass substrate and the contact portion of the molded article is not beforehand heated, and after the glass substrate and the molded article are brought into contact with each other, the contact portion of the molded article may be heated. The point is that under the condition that the molded article is in contact with the glass substrate, it is only required to realize the condition that the temperature of the contact portion of the molded article is T₁(° C.). For example, even after the molded article and the glass substrate are brought into contact with each other, by bringing a heater into contact with the glass substrate or the resin, the contact portion can be heated by heat conduction.

Additionally, in the above-described embodiment, the bottom surface 22a of the contact portion 22c of the molded article has the raised line 24 so as to surround the through-hole 21; however, in place of the raised line 24, a plurality of protrusions disposed so as to surround the through-hole 21 may also be adopted, or alternatively, even if the bottom surface 22a does not have a raised line or protrusions, the present invention can be embodied.

Additionally, in the above-described embodiment, as the molded article, the lid frame 20 used for the case for housing a semiconductor element is presented; however, examples of the molded article are not limited to this case, and may include any molded bodies having any shapes and any purposes as long as the molded bodies are liquid crystalline polymer molded bodies capable of being fusion bonded to glass substrates.

Examples of the composite article including a liquid crystalline polymer molded article and a glass substrate fusion bonded to each other by the method of present invention may include: integrally molded products involving lenses, prisms, mirrors and the like and liquid crystalline polymer molded bodies; components of optical apparatuses such as contact image sensors, image scanners, banking machines (such as banknote readers) and CCD camera covers; jig components for use in semiconductor production devices, lighting devices and window panels for automobiles and buildings.

### Examples

Hereinafter, Examples and Comparative Examples are described specifically, but the present invention is not limited to these.

### Example 1

A lid frame molded in the shape shown in FIG. 1 by using a liquid crystalline polymer (Sumika Super LCP E6808THF BZ, manufactured by Sumitomo Chemical Co., Ltd., flow initiation temperature T₂: 306° C., decomposition initiation temperature T₃: 499° C.) was set as a molded article to the molded article holder of a thermal fusion bonding apparatus, and a glass plate (D263, manufactured by Matsunami Glass Ind., Ltd., thickness: 0.40 mm) having a shape shown in FIG. 2 was set to the glass substrate holder of the thermal fusion bonding apparatus. Under the condition that the glass plate was heated with a heater to 400° C., the glass plate was brought into contact with the lid frame by elevating an air cylinder. In this case, the glass plate was pressed against the lid frame with a pressure of 2.0 MPa for 3 seconds and then the fusion bonded product was cooled to yield a lid as a composite article.

### Example 2

The operations were performed in the same manner as in Example 1 except that the pressing time was altered to 5 seconds.

### Example 3

The operations were performed in the same manner as in Example 1 except that a glass plate subjected to a surface treatment with magnesium fluoride was used.

### Example 4

The operations were performed in the same manner as in Example 1 except that the heating temperature of the glass plate was set at 420° C.

### Example 5

The operations were performed in the same manner as in Example 4 except that a glass plate subjected to a surface treatment with magnesium fluoride was used and the glass plate was pressed against the lid frame with a pressure of 1.7 MPa.

### Example 6

The operations were performed in the same manner as in Example 5 except that the pressing was performed with a pressure of 2.0 MPa.

### Example 7

The operations were performed in the same manner as in Example 4 except that a glass plate subjected to a surface roughening treatment by a sand-blasting method was used.

### Comparative Example 1

The operations were performed in the same manner as in Example 1 except that the glass plate was heated to 380° C., but the resin molded article and the glass plate were not fusion bonded to each other.

### Comparative Example 2

A production of a composite article composed of the lid frame and the glass plate used in Example 1 was attempted by using an ultrasonic welder (2000ea20, manufactured by Emerson Japan, Ltd., Branson Ultrasonics Division), under the following conditions, but the lid frame and the glass plate were not fusion bonded to each other.

Excitation frequency: 20 (kHz)

Amplitude: 70(%)

Welding pressure: 0.3 (MPa)

Oscillation time: 0.3 (second)

Cooling retention time: 0.1 (second)

### Comparative Example 3

The operations were performed in the same manner as in Comparative Example 2 except that a glass plate subjected to a surface treatment with magnesium fluoride was used, but the lid frame and the glass plate were not fusion bonded to each other.

The air-tightness of the contact portion of each of the obtained composite bodies was measured by using a He leak detector (HELEN M-222LD-H, manufactured by Canon Anelva Corp.). The proportion of the samples having a He leak value of less than 1.0×10⁻⁸ (Pa·m³/sec) was defined as the yield (%). The results thus obtained are shown in Table 1.

TABLE 1

| | Surface treatment/ | | | | |
|---|---|---|---|---|---|
| | surface | | | | |
| | roughening | | | | |
| | treatment of glass | Temperature of | Pressure at | Pressing time | Air-tightness |
| | plate | contact portion (° C.) | pressing (MPa) | (sec) | (%) |
| Example 1 | None | 400 | 2.0 | 3 | 20 |
| Example 2 | None | 400 | 2.0 | 5 | 50 |
| Example 3 | Magnesium | 400 | 2.0 | 3 | 50 |
| | fluoride | | | | |
| Example 4 | None | 420 | 2.0 | 3 | 20 |
| Example 5 | Magnesium | 420 | 1.7 | 3 | 60 |
| | fluoride | | | | |
| Example 6 | Magnesium | 420 | 2.0 | 3 | 90 |
| | fluoride | | | | |
| Example 7 | sand-blasting | 420 | 2.0 | 3 | 80 |
| Comparative | None | 380 | 2.0 | 3 | Not fusion |
| Example 1 | | | | | bonded |

| | | | |
|---|---|---|---|
| Comparative | None | -(Ultrasonic welding) | Not fusion bonded |
| Example 2 | | | |
| Comparative | Magnesium | -(Ultrasonic welding) | Not fusion bonded |
| Example 3 | fluoride | | |

What is claimed is:

1. A method for fusion bonding a molded article of a liquid crystalline polymer and a glass substrate to each other, comprising:
bringing the molded article into contact with the glass substrate; and
setting the temperature of a contact portion of the molded article in contact with the glass substrate, at a predetermined temperature,
wherein when the predetermined temperature of the contact portion is represented by T₁(° C.), a flow initiation temperature of the liquid crystalline polymer is represented by T₂(° C.) and a decomposition initiation temperature of the liquid crystalline polymer is represented by T₃(° C.), the following relation is satisfied:
T₃(° C.)>T₁(° C.)≧T₂(° C.)+80° C.

2. The method according to claim 1, further comprising pressing the glass substrate against the contact portion under the condition that the temperature of the contact portion is set at T₁

3. The method according to claim 2, wherein the pressing is performed at a pressure of 10 MPa or less.

4. The method according to claim 2, wherein the time period of the pressing is 10 seconds or less.

5. The method according to claim 3, wherein the time period of the pressing is 10 seconds or less.

6. The method according to claim 1, wherein a surface of the glass substrate brought into contact with the molded article is being surface treated with at least one selected from the group consisting of magnesium fluoride, zirconia and aluminum oxide.

7. The method according to claim 1, wherein a surface of the glass substrate brought into contact with the molded article is being surface roughened.

8. The method according to claim 1, wherein the contact portion has one or more protrusions.

9. A composite article comprising the molded article of a liquid crystalline polymer and the glass substrate, fusion bonded to each other by the method according to claim 1.
